(19) United States
(12) Patent Application Publication
(10) Pub. No.: US 2008/0303363 A1
(43) Pub. Date: Dec. 11, 2008

(54) Energy storage and gyroscopic stabilizing system

(75) Inventor: Gerald Allen Alston, Union City, CA (US)

Correspondence Address: FOLEY AND LARDNER LLP;SUITE 500, 3000 K STREET NW, WASHINGTON, DC, 20007, US

(73) Assignee: Glacier Bay, Inc.

(21) Appl. No.: 11/808,468

(22) Filed: Jun. 11, 2007

(51) Int. Cl. B63B 43/04; B63B 39/04; H02K 7/02; H02K 7/116

(52) U.S. Cl. 310/74; 114/122; 310/83

(57) ABSTRACT

The disclosed energy storage and gyroscopic stabilizing system may be used in a marine vessel so as to supply energy, retrieve energy, and dampen the roll motion of the marine vessel. The system may comprise a rotating member configured to be rotatable and to dampen a roll motion of the marine vessel and a motor/generator in communication with the rotating member and configured to supply energy to and retrieve energy from the rotating member.

### BACKGROUND

The present invention related to an energy storage and gyroscopic stabilizing system in marine vessels, such as yachts and small boats.

The use of gyroscopic stabilizing systems used for marine vessels are known in the art. These systems are used to suppress the rolling motion that occurs in boats and small ships. In one such system, a flywheel is mounted on a one-degree-of-freedom gimbal structure, and spun about a spin axis using a driver motor. The spin axis of the flywheel is permitted to rotate about a gimbal axis, which is perpendicular to the spin axis and the longitudinal axis of the boat. For example, the spin axis of the flywheel can be vertical and the gimbal axis can run from port to starboard, or vice versa. Angular momentum is stored in the spinning flywheel. Thus, when the boat is subjected to a rolling motion, the conservation of the angular momentum of the flywheel causes the flywheel to rotate about the gimbal axis such that the stabilizer's gyroscopic action resists the rolling motion, i.e., it “pushes back” against the waves. If the rate of rotation about the gimbal axis is controlled, a useful gyroscopic torque is imposed about the roll (or longitudinal) axis of the boat, with the net effect that rolling motion is dampened, i.e., the roll is minimized and the boat is stabilized. The damping effect is directly proportional to (a) the rate of rotation of the flywheel, (b) the mass of the flywheel, (c) the square of the radius of gyration of the flywheel and (d) the rate at which the gyro is rotated.

U.S. Pat. No. 6,973,847 (herein incorporated by reference) discloses a gyroscopic roll stabilizer for boats. This particular stabilizer includes a flywheel, a flywheel drive motor configured to spin the flywheel about a spin axis, an enclosure surrounding a portion or all of the flywheel and maintaining a below-ambient pressure or containing a below-ambient density gas, a gimbal structure configured to permit flywheel precession about a gimbal axis, and a device for applying a torque to the flywheel about the gimbal axis. The flywheel, enclosure, and gimbal structure are configured so that when installed in the boat the stabilizer dampens the roll motion of the boat.

Besides being used in gyroscopic stabilizing systems, flywheels have also been used in energy storage systems. In this application, the flywheel acts like a mechanical battery by storing energy in the form of kinetic energy. The spinning flywheel may maintain and store inertial energy. With a high efficiency and long lifetime, the flywheel can be a very effective alternative to batteries for providing energy that may provide power various systems or appliances onboard a vessel. For example, in a conventional system, the energy storage system may comprise a rotor suspended by bearings and connected to a combination electric motor/generator. A vacuum chamber may be used so as to reduce friction. Older energy storage systems included large steel flywheels rotating on mechanical bearings. The main drawback to the use of such flywheels in energy storage systems has been the danger associated with overload and resulting explosions. Thus, new composite materials are used which disintegrate rather than shatter. For example, carbon-fiber composite rotors are utilized which are stronger than steel and considerably lighter. Furthermore, a strong container may be used to catch any hot material in the event of an overload failure. Instead of mechanical bearings, magnetic levitation may be used instead so as to increase the energy efficiency by eliminating the drag imposed by conventional mechanical bearings. Energy is stored by using the motor/generator to increase the speed of the spinning flywheel. If needed, the system releases its energy by using the momentum of the flywheel to power the motor/generator.

One example of a kinetic energy storage system for a vehicle is disclosed in U.S. Pat. No. 5,931,249 (herein incorporated by reference). This kinetic energy storage system comprises a flywheel with a motor/generator to store energy. The flywheel rotor is located in an elongate housing which forms at least part of a rigid framework of the vehicle, such as the chassis for the vehicle. The flywheel rotates at a high speed in a vacuum such that the vehicle may be powered from the flywheel.

In another example, U.S. Pat. No. 4,088,041 (herein incorporated by reference) discloses an energy storing flywheel drive, which includes two flywheels rotatably supported in a housing for rotation about a common axis. The flywheels are operatively connected to a common shaft through respectively planetary type traction roller transmissions. One flywheel is connected to a sun member and an input-output shaft associated with the planetary members of one planetary transmission while its outer ring member is mounted in the housing. The other flywheel is connected to the sun member and the input-output shaft is connected to the outer ring member of the other planetary transmission while its planetary members are mounted on the housing thereby to cause, upon rotation of the input-output shaft, rotation of the flywheels in opposite directions. The transmission ratios of the planetary transmissions are selected so as to prevent the generation of gyroscopic forces.

Although there are examples of gyroscopic marine stabilizers and many versions of flywheel energy storage systems, there are no systems to be found in the prior art which combine these two functions for marine vessels.

### SUMMARY

According to one embodiment of the present invention, an energy storage and gyroscopic stabilizing system for a marine vessel is disclosed. The system may comprise a supporting structure; a rotating member rotatably supported by the supporting structure; and a motor/generator connected in communication with the rotating member and configured to supply energy to and retrieve energy from the rotating member. The rotating member may be configured to dampen a roll motion of the marine vessel.

According to another embodiment of the present invention, a marine vessel is disclosed, which comprises an energy storage and gyroscopic stabilizing system. The system may comprise a supporting structure; a rotating member rotatably supported by the supporting structure; and a motor/generator connected in communication with the rotating member and configured to supply energy to and retrieve energy from the rotating member. The rotating member is configured to dampen a roll motion of the marine vessel.

In yet another embodiment of the present invention, an energy storage and gyroscopic stabilizing system for a marine vessel is disclosed, which comprises a rotating member configured to be rotatable and to dampen a roll motion of the marine vessel and a motor/generator connected in communication with the rotating member and configured to supply energy to and retrieve energy from the rotating member.

It is to be understood that both the foregoing general description and the following detailed descriptions are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIGS. 1A and 1B are schematic views of the placement of an energy storage and gyroscopic stabilizing system in a marine vessel.

FIG. 2 is a schematic view of the energy storage and gyroscopic stabilizing system according to an embodiment of the present invention.

FIGS. 3A and 3B shows the connection of the energy storage and gyroscopic stabilizing system to various other systems in the marine vessel.

FIG. 4 is a schematic view of the energy storage and gyroscopic stabilizing system according to an embodiment of the present invention

FIG. 5 is a schematic view of the system of FIG. 4 as seen along sectional line A-A.

FIG. 6 is a schematic view of the energy storage and gyroscopic stabilizing system according to another embodiment of the present invention.

FIG. 7 is a schematic view of the system of FIG. 6 as seen along sectional line B-B.

FIG. 8 is a schematic view of the system of FIG. 2 with a vacuum system.

FIG. 9 is a schematic view of the system of FIG. 4 with a vacuum system.

FIG. 10 is a schematic view of the system of FIG. 6 with a vacuum system.

### DETAILED DESCRIPTION

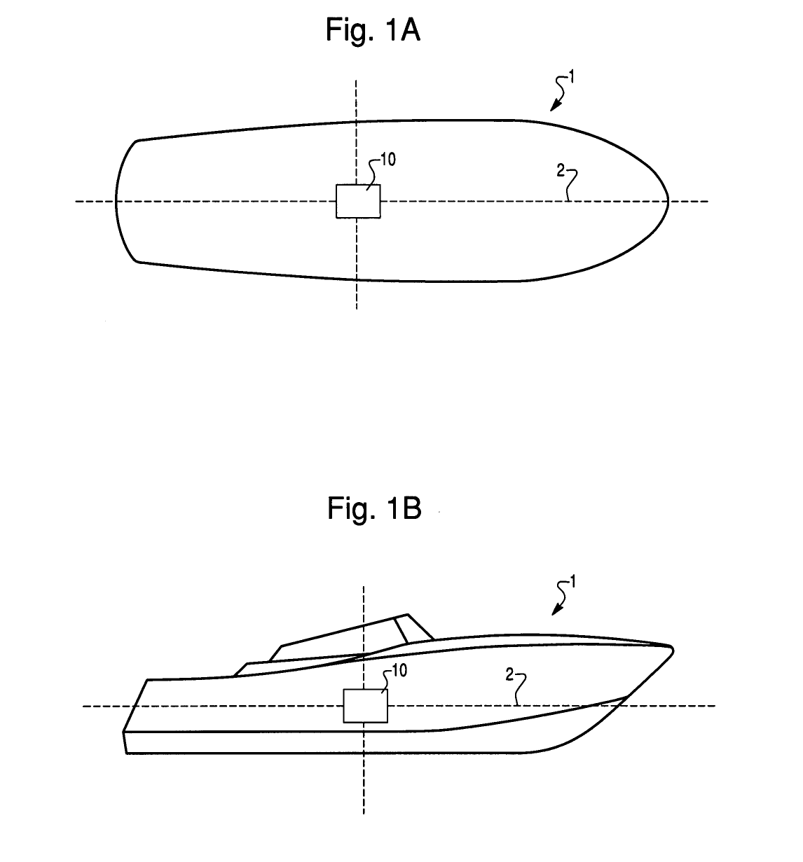

Embodiments of the present invention may be able to provide both gyroscopic stabilization and energy storage for a marine vessel. FIGS. 1A and 1B shows schematic views of a marine vessel 1 with the energy storage and gyroscopic stabilizing system 10 mounted along the longitudinal axis 2 of the vessel. Although the system 10 is shown in the center of the vessel 1, any suitable position in the marine vessel is possible.

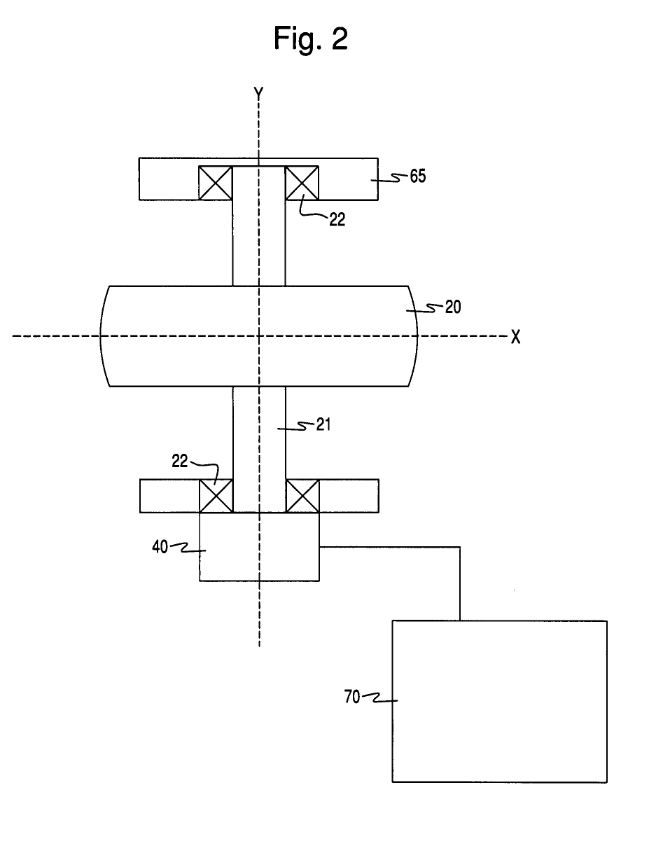

FIG. 2 shows schematic views of the energy storage and gyroscopic stabilizing system according to an embodiment of the present invention. The system 10 may include a rotating member 20, a supporting structure 65, a motor/generator 40, and a control system 70.

The rotating member 20 may be a flywheel, which is connected to the motor-generator 40 via a rotating shaft 21. The rotating shaft, in turn, is supported on either end by bearings 22. The rotating member is capable of spinning at high speeds about the y-axis, which is the vertical axis. The rotating member can be any suitable configuration such as a disc having uniform thickness or more mass on its outer circumference. The rotating member may be made of metal (such as steel) or a laminated fiber composite (e.g., a laminated carbon fiber). Material selection may depend on hull shape, vessel type and desired energy generation and storage capabilities. For example, a relatively large and heavy rotating member may perform best for both stabilization and energy storage. However, the system 10 may be optimized such that it can be installed on smaller boats without compromising its effectiveness at performing either of its tasks of stabilization or energy storage. The bearings 22 may be any suitable type of bearing, such as a mechanical roller bearings or magnetic levitation coupling.

The rotating member 20, the shaft 21, and the bearings 22 are supported by the supporting structure 65, which is statically mounted onto the marine vessel. The housing may be a simple structure that permits the spinning of the shaft 21 on the bearings 22. For example, the supporting structure 65 can merely be two fixed walls running parallel to each other with apertures in which the bearings 22 may rotate. In this embodiment, the spinning of the rotating member itself dampens the rolling motion of the vessel as the rolling motion must overcome the angular momentum of the rotating member. In one embodiment, the rotating member is a heavy steel disc rotated on mechanical roller bearings.

The rotating member 20 may be rotated at high angular velocities by the motor/generator 40. These speeds can range from 2500 to 150,000 rpm. The motor/generator may be provided in many different forms. In one embodiment, the motor/generator may be at one end of the rotating shaft 21, and include a stator fastened to the supporting structure 65 and a rotor fastened to the shaft 21. In another embodiment, the motor/generator 40 may be connected outside of the supporting structure 65 such that the shaft 21 extends through the supporting structure 65 so as to connected to the motor/generator, as seen in FIG. 2.

The motor/generator 40 is connected to a control system 70 of the marine vessel so as to provide power to the vessel. The control system allows the system 10 to provide power to the electronic systems that are usually conventional with a marine vessel, such as the engine, navigational and radio equipment, and braking equipment.

In addition to its energy storage and stabilizing functions, the energy storage and gyroscopic stabilizing system 10 may have additional functions. For example, the marine vessel may be a diesel/electric craft that includes one or more power sources, such as solar panels, a combustion engine, and/or wind generators. The engine that runs off these power sources may have a point of operation where it runs at the most efficient, for example 50 kW. However, there can be circumstances where the most efficient operation cannot be obtained because there is insufficient electrical load, for example only a 40 kW load is achieved. The energy storage and gyroscopic stabilizing system 10 may be used as an electrical load bearing device so that that most efficient operation, at 50 kW, can be obtained.

Another function for the system 10 may be as an assisted braking function to be used in conjunction with, or as an alternative to, braking resistors. Brake resistors are used for the controlled stopping of electric motors where natural friction or mechanical braking is insufficient or inappropriate. In this case, when assistance in braking is needed, the energy storage and gyroscopic stabilizing system 10 is connected to the power motor of the marine craft so that part of the kinetic energy (that would otherwise be lost to heat) of the marine vessel is recaptured by the spinning rotating member when braking.

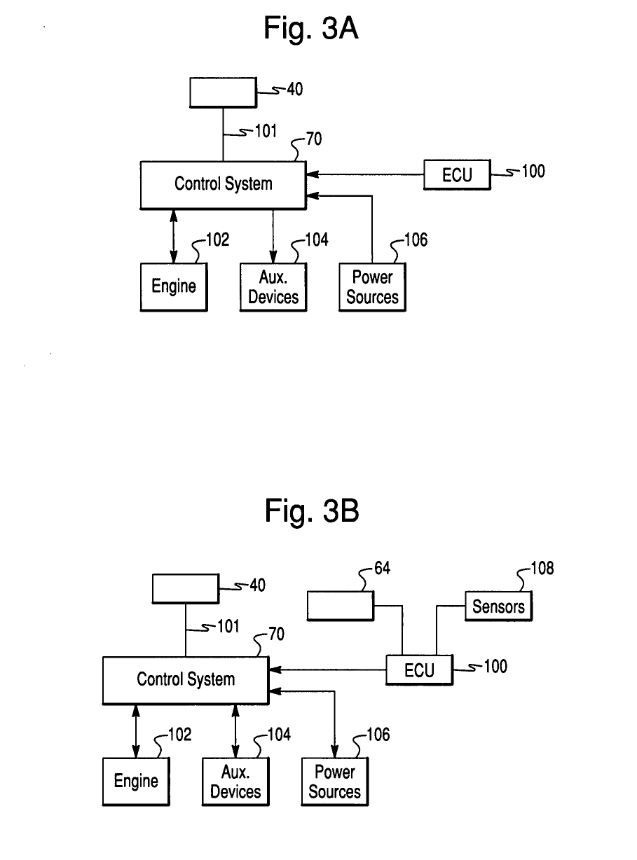

FIG. 3A shows the connection of the output/input of the motor/generator 40 with the control system 70 for the embodiment of FIG. 2. The output/input of the motor generator 40 is connected to the control system 70, which can be a series of connection switches controlled by an electronic control unit or controller 100 (ECU). These switches can connect the line 101 leading to the motor-generator 40 to one or more of a variety of systems based on commands from the ECU 100. The ECU controls the switches to provide for operation of the electrical rotating machine (motor/generator 40) as either a motor or generator. For example, the ECU may electronically configures the switches to provide either an inverter function (for a motor) or an active rectification function (for a generator). The switches may be IGBTs, for example.

The electrical system of the engine 102 can be connected to the motor/generator 40 so as to either provide energy to or receive energy from the motor/generator 40. Auxiliary devices, such as lights or a radio, can be hooked up to the motor/generator 40 so as to provide power to these devices. Power devices, such as solar panels, can be hooked up to the motor/generator so as to provide power to the system 10 for latter usage. The ECU 100 can connect up one or more of these devices (if present) by monitoring the power availability or need in the motor/generator 40, the engine 102, the auxiliary devices 104, and the power sources 106, and make the appropriate connection based on such monitoring. Alternatively or additionally, the ECU 100 can be configured to make the suitable connections based on operator input.

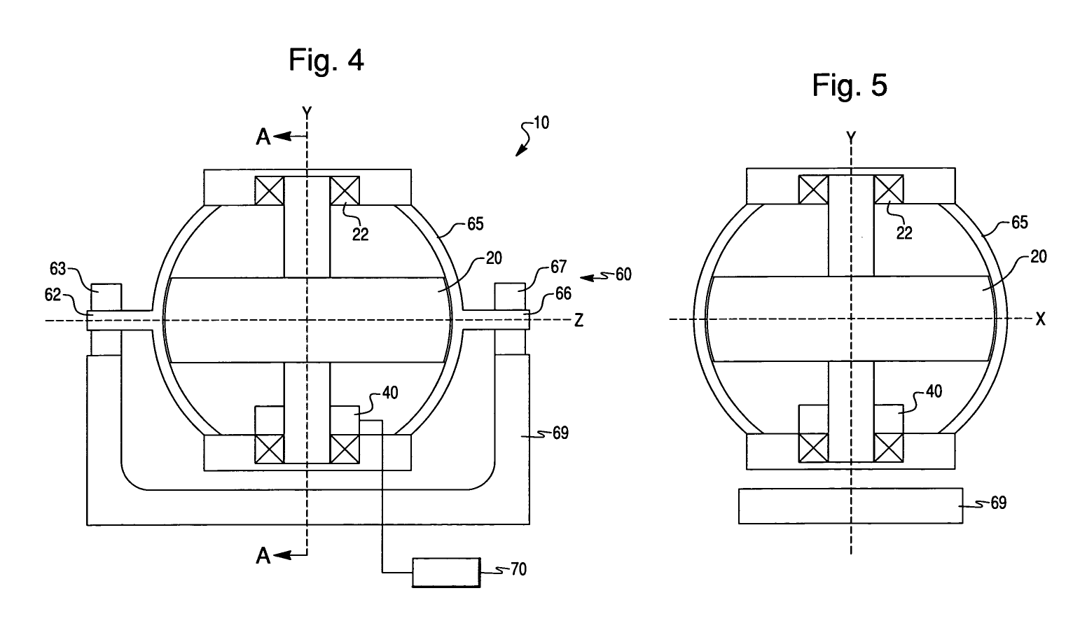

FIGS. 4 and 5 show schematic views of the energy storage and gyroscopic stabilizing system 10 according to another embodiment of the present invention. The system 10 may include a rotating member 20, a supporting structure 65, a motor/generator 40, a gimbal structure 60, and a control system 70.

As with the embodiment of FIG. 2, the rotating member 20 is connected to the motor-generator 40 via a rotating shaft 21, which is support on either end by bearings 22. The rotating member is capable of spinning at high speeds about the y-axis, and may be any suitable configuration. The bearings 22 may be any suitable type of bearing.

The rotating member 20, the shaft 21, and the bearings 22 are supported by the supporting structure 65. The supporting structure is connected to a gimbal structure 60, which permits the rotating member 20 to be rotated along a gimbal axis. With this rotation along the gimbal axis, the rotating member can be made physically smaller (and be made from lighter material); however, there is a trade-off in that there is less energy storage possible than from the embodiment of FIG. 2.

The supporting structure 65 may be any suitable shape, for example substantially spherical, two perpendicular rings, or other shape. In the case that the rotating member is made of a composite, lighter material such as a laminated fiber composite. The supporting structure may enclose the rotating member so as to act as a protective shield in the event that the rotating members starts to break apart such that the remnants of the rotating member after break up are contained. To that end, the enclosed supporting structure 65 should be made of a strong and durable material and corrosion resistant material (e.g., bronze, stainless steel and titanium).

Also, as with the embodiment of FIG. 2, the rotating member 20 may be rotated at a high angular velocity by the motor/generator 40. The motor/generator 40 may be at one end of the rotating shaft 21 within the protective shield of the supporting structure or may be outside the protective shield.

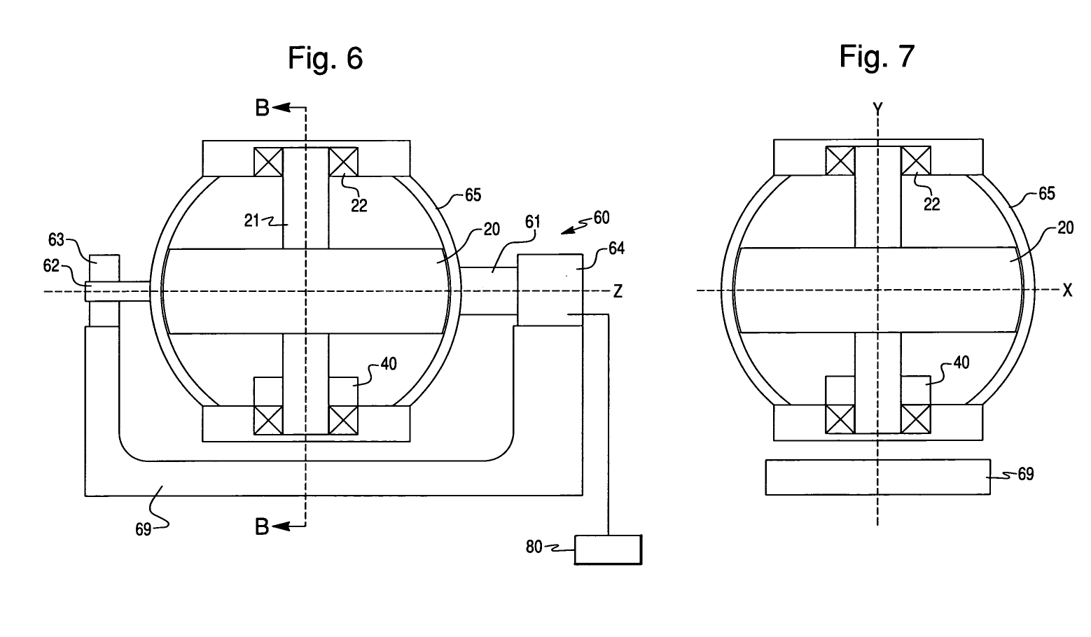

The gimbal structure 60 supports the supporting structure 65 so that the rotating member 20 can rotate about the z-axis (i.e., the gimbal axis) that is perpendicular to the y-axis (i.e., the spin axis of the rotating member). For example, the gimbal axis extends from port to starboard, and the spin axis of the rotating member is vertical, so that both axes are perpendicular to the longitudinal axis of the boat (i.e., the x-axis). The spin axis is able to rotate about the gimbal axis, resulting in the spin axis tilting forward or aft in a vertical plane that passes through the longitudinal axis of the boat. The gimbal structure 60 includes gimbal shafts 61 and 66 extending from each side of the supporting structure 65. The gimbal shafts are supporting by one or more gimbal bearings 63 and 65. The gimbal structure 60 may be statically mounted (as seen in FIGS. 4 and 5) or may be powered (as shown in FIGS. 6 and 7).

In the embodiment of FIGS. 4 and 5, the gimbal structure rotates about the gimbal axis that runs along gimbal shafts 62 and 66, which are mounted via bearings 63 and 67 to a supporting structure 69. The supporting structure 69 is statically mounted to the marine vessel (i.e., not powered by a driving mechanism) and may be any suitable configuration for supporting the system 10.

In the embodiment of FIGS. 6-7, a rotating mechanism 64 is connected to either gimbal shaft 61 or 62. The rotating member 20, the housing 30, the motor/generator 40, the gimbal shafts 61 and 62, the gimbal bearings 63, and the rotating mechanism 64 are all supported by a support structure 69. The support structure 69 may be any suitable configuration for supporting the system 10. As to the rotating mechanism 64, this device is used to apply a torque to the rotating member 20 about the gimbal axis (hereinafter called the “gimbal torque”). The torque is applied to one of the gimbal shafts 61 or 62, and thereby to the rotating member 20 and the supporting structure 65. The rotating mechanism 64 may be any suitable mechanism, such as an active device, which vary or apply the gimbal torque as a function of one or more parameters, such as roll acceleration, roll rate, or roll angle.

FIG. 3B shows the connection of the output/input of the motor/generator 40 with the control system 70 for the embodiment of FIG. 6. One or more sensors 108 measure one or more parameters, which are then provided to the ECU 100 via an electrical signal representative of the parameter. The ECU 100, in turn, controls the rotating mechanism 64 so that it applies the gimbal torque about the gimbal axis. For example, wave forces applied to the boat, provide a torque about the longitudinal axis of the boat, resulting in a rolling motion, which can be characterized by a roll angle and roll rate. The roll rate of the boat creates a torque about the gimbal axis. A sensor 108 measures the vessel's roll rate (or roll acceleration, which is integrated to provide the roll rate) and the measured roll rate is fed to the ECU 100. The ECU 100 then controls the rotating mechanism 64 for applying a torque about the gimbal axis. By controlling the amount of torque applied in opposition to the torque about the gimbal axis, the system 10 is allowed to rotate in a controlled manner and a gyroscopic torque is produced about the vessel's longitudinal axis which dampens or reduces the vessel's roll motions. The rotating mechanism can be one or more of the following: hydraulic linear or rotary actuators, mechanical brakes such as a drum brake or disc brakes; magnetic brakes; electromagnetic brakes; and/or electrical brakes such as a generator wherein the generator load is actively controlled to vary the damping torque.

In one embodiment, the rotating mechanism 64 is a geared mechanism that allows a driving mechanism (such as a motor or linear actuator) to move against the rotating member's resistance to increase the stabilizing effect. For comparison, if the rotating member and its housing were mounted solidly in the boat, when a wave rolls the boat 5° the resistance available to fight that rolling motion would equal 5° of gyro movement. However, if the rotating member/gyro were mounted on a powered gimbal as in FIGS. 6 and 7, it would then be possible to move the rotating member 10° to 20° to counteract against the 5° roll of the boat. The disadvantage is that the system is now powered and no longer passive, but the advantage is that it would be possible to get much more stabilizing power out of a smaller rotating member.

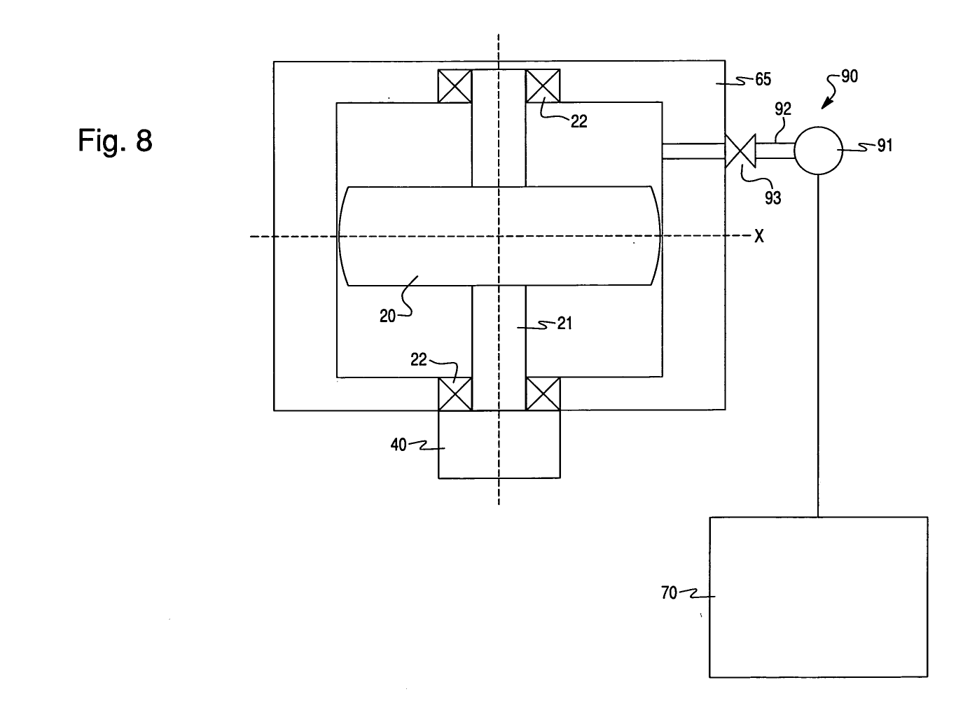

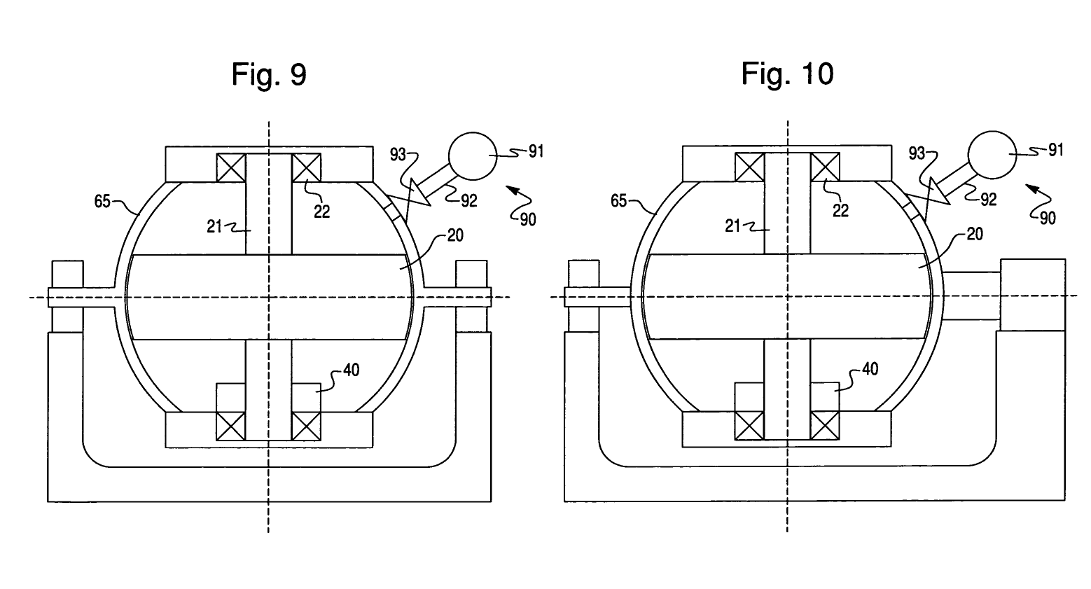

FIGS. 8 through 9 show schematic views of the energy storage and gyroscopic stabilizing system according to other embodiments of the present invention. The system 10 may include a rotating member 20, a supporting structure 65 in the form of an enclosed vacuum housing, a motor/generator 40, and a control system 70.

As with the embodiments of FIGS. 2, 4, and 6, the rotating member 20 is connected to the motor-generator 40 via a rotating shaft 21, which is support on either end by bearings 22. The rotating may be made of a light composite material and supported by magnetic coupling bearings 22. In these embodiments, the supporting structure 65 takes the form of a vacuum housing, which is connected to vacuum system 90. The vacuum system 90 may comprise a vacuum pump 91; a vacuum tubing 91 that connects the vacuum pump 90 to the supporting structure 65; and an optional flow valve 93 that is controlled by the ECU. The pump and valve may be operated at times when the vacuum pressure within the vacuum housing (as detected by a pressure sensor (not shown)) is below a predetermined threshold value.

The rotating member 20, the shaft 21, and the bearings 22 may be encased, i.e., sealed, in the supporting structure 65. The supporting structure 65 may be any suitable shape, for example substantially spherical or other shape. In this embodiment, the supporting structure provides two purposes. First, the supporting structure 65 acts as a protective shield (or housing) in the event that the rotating member starts to break apart so as to contain the remnants of the rotating member after break up. Second, the supporting structure acts as a vacuum chamber in which the rotating member spins. The vacuum pressure decreases the amount of drag on the rotating member 20 as it spins. The vacuum pressure may be any suitable pressure below atmospheric. For example, the pressure is preferably below 0.5 atmospheres, 0.25 atmospheres, 0.10 atmospheres, or lower. Alternatively or additionally, a gas with a lower density than air, for example, helium, may be contained within the housing for the purpose of reducing the amount of drag acting on the rotating member. In such an embodiment, the vacuum pump may be replaced with a gas supply that has the lower density gas.

As to the motor/generator, the motor/generator 40 can be placed in any suitable location. For example, the motor/generator 40 may be at one end of the rotating shaft 21 inside the vacuum chamber or may be connected outside the vacuum chamber. In the latter case, the shaft 21 may fit in an aperture in the vacuum chamber, and an O-ring or other dynamic seal may be used to prevent leakage between the rotating shaft 21 and the inner surface of the aperture in the vacuum chamber.

Disclosed is an apparatus and method used to store energy and perform gyroscopic stabilization using a single device in a marine vessel. Other embodiments of the present invention, not explicitly shown above, are contemplated with the scope of the invention. For example, the marine vessel may have a plurality of energy storage and gyroscopic stabilizing systems (not just one as shown in the above figures). In other embodiments, other orientations and locations of the rotating member and gimbal axis are possible so long as the net effect is that the system dampens roll motions of the boat. For example, the spin axis of the rotating member could be oriented in the port to starboard direction, and the gimbal axis may be oriented vertically.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An energy storage and gyroscopic stabilizing system for a marine vessel, comprising:
a supporting structure;
a rotating member rotatably supported by the supporting structure; and
a motor/generator connected in communication with the rotating member and configured to supply energy to and retrieve energy from the rotating member;
wherein the rotating member is configured to dampen a roll motion of the marine vessel.

2. The energy storage and gyroscopic stabilizing system according to claim 1, further comprising a gimbal structure configured to rotate the rotating member about a gimbal axis which is different from a spinning axis of the rotating member.

3. The energy storage and gyroscopic stabilizing system according to claim 1, wherein the rotating member is mounted in a geared mechanism that allows a driving mechanism to move against a resistance of the rotating member so as to increase the stabilizing effect.

4. The energy storage and gyroscopic stabilizing system according to claim 3, wherein the driving mechanism comprises a motor or a linear actuator.

5. The energy storage and gyroscopic stabilizing system according to claim 1, wherein the supporting structure and the rotating member are configured to be statically mounted to the marine vessel.

6. The energy storage and gyroscopic stabilizing system according to claim 1, wherein the rotating member is a flywheel.

7. The energy storage and gyroscopic stabilizing system according to claim 6, wherein the flywheel comprises a composite material mounted on magnetic bearings.

8. The energy storage and gyroscopic stabilizing system according to claim 6, further comprising a vacuum housing encasing the flywheel.

9. The energy storage and gyroscopic stabilizing system according to claim 6, wherein the flywheel comprises a steel disc mounted on mechanical roller bearings.

10. A marine vessel, comprising:
an energy storage and gyroscopic stabilizing system, comprising:
a supporting structure;
a rotating member rotatably supported by the supporting structure; and
a motor/generator connected in communication with the rotating member and configured to supply energy to and retrieve energy from the rotating member;
wherein the rotating member is configured to dampen a roll motion of the marine vessel.

11. The marine vessel according to claim 10, further comprising a gimbal structure configured to rotate the rotating member about a gimbal axis which is different from a spinning axis of the rotating member.

12. The marine vessel according to claim 1, wherein the rotating member is mounted in a geared mechanism and further comprising a driver connected to the geared mechanism so as to move against a resistance of the rotating member so as to increase the stabilizing effect.

13. The marine vessel according to claim 1, wherein the supporting structure and the rotating member are configured to be statically mounted to the marine vessel.

14. The marine vessel according to claim 1, wherein the rotating member is a flywheel.

15. An energy storage and gyroscopic stabilizing system for a marine vessel, comprising:
a rotating member configured to be rotatable and to dampen a roll motion of the marine vessel; and
a motor/generator in communication with the rotating member and configured to supply energy to and retrieve energy from the rotating member.

16. The energy storage and gyroscopic stabilizing system according to claim 15, further comprising a gimbal structure configured to rotate the rotating member about a gimbal axis which is different from a spinning axis of the rotating member.

17. The energy storage and gyroscopic stabilizing system according to claim 15, wherein the rotating member is mounted in a geared mechanism that allows a driver to move against a resistance of the rotating member so as to increase the stabilizing effect.

18. The energy storage and gyroscopic stabilizing system according to claim 15, wherein the rotating member is configured to be statically mounted to the marine vessel.

19. The energy storage and gyroscopic stabilizing system according to claim 15, wherein the rotating member is a flywheel.

20. An energy storage and gyroscopic stabilizing system for a marine vessel, the system including a rotating member rotatably supported by a supporting structure, wherein the rotating member is configured to dampen a roll motion of the marine vessel; and an electrical rotating machine connected in communication with the rotating member and configured to supply energy to and retrieve energy from the rotating member, wherein the electrical rotating machine is configured for operation as either a motor or a generator and wherein the system includes switches that are configured by a controller to provide either an inverter or rectifier function.
